(19) United States
(12) Patent Application Publication
(10) Pub. No.: US 2019/0100196 A1
(43) Pub. Date: Apr. 4, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Yugo Ueda, Wako-shi (JP); Atsushi Arai, Tokyo (JP)

(21) Appl. No.: 16/139,102

(22) Filed: Sep. 24, 2018

(30) Foreign Application Priority Data
Oct. 4, 2017 (JP) 2017-194599

(51) Int. Cl. B60W 30/09; G06K 9/00; G06T 7/20; G08G 1/16

(52) U.S. Cl. CPC B60W 30/09; G06K 9/00805; G06T 2207/30261; G08G 1/166; G06T 7/20

(57) ABSTRACT

A vehicle control device (100) of an embodiment includes a moving object recognition unit (131) configured to recognize a moving object that is crossing or is estimated to be about to cross a road on which a vehicle is traveling in a traveling direction of the vehicle, a specifying unit (132) configured to specify an area in which the vehicle is traveling, and avoidance control units (133, 134, 135, 142, 144, and 160) configured to avoid contact with a moving object recognized by the moving object recognition unit by controlling one or both of steering and/or acceleration and deceleration of the vehicle without depending on an operation of a driver of the vehicle, and to change an operation condition of the avoidance control on the basis of an area specified by the specifying unit.

### CROSS-REFERENCE TO RELATED APPLICATION

Priority is claimed on Japanese Patent Application No. 2017-194599, filed Oct. 4, 2017, the content of which is incorporated herein by reference.

### BACKGROUND OF THE INVENTION

### Field of the Invention

The present invention relates to a vehicle control device, a vehicle control method, and a storage medium.

### Description of Related Art

In recent years, research on automatic control of a vehicle has progressed. In connection with this, a technology of calculating, for a host vehicle, a probability of collision with a target object present within a predetermined detection area ahead of the host vehicle, and, if the calculated probability of collision is equal to or more than a reference value, starting automatic braking control of the host vehicle is known (for example, refer to PCT International Publication No. WO2012/147166).

### SUMMARY OF THE INVENTION

However, depending on a country or region, there are places where it is normal for an object to cross the road by passing near a vehicle in motion, and if automatic braking control is activated based on the probability of collision determined based on a certain criterion, there may be cases where other traffic is obstructed.

Aspects of the present invention have been made in view of such circumstances, and an object thereof is to provide a vehicle control device, a vehicle control method, and a program which can execute driving control in accordance with countries and regions.

A vehicle control system, a vehicle control method, and a storage medium according to the present invention adopt the following configurations.

(1): A vehicle control system according to an aspect of the present invention is a vehicle control device which includes a moving object recognition unit configured to recognize a moving object that is crossing or is estimated to be about to cross a road on which a vehicle is traveling in a traveling direction of the vehicle, a specifying unit configured to specify an area in which the vehicle is traveling, and an avoidance control unit configured to avoid contact with a moving object recognized by the moving object recognition unit by controlling one or both of a steering and/or an acceleration or deceleration of the vehicle independently of an operation of a driver of the vehicle and to change operation conditions for the avoidance control on the basis of an area specified by the specifying unit.

(2): In the aspect (1) described above, the avoidance control unit estimates whether there is a probability that crossing of a road by the moving object to be avoided will be delayed by performing the avoidance control, and changes an operation condition such that the avoidance control is less likely to operate when it is estimated that there is a probability that crossing of a road by the moving object to be avoided will be delayed.

(3): In the aspect (1) described above, the avoidance control unit, when the road on which the vehicle travels is a road having a plurality of lanes, estimates whether there is a probability that crossing of a road by the moving object to be avoided will be delayed due to an influence of other vehicles traveling on the plurality of lanes by performing the avoidance control, and changes the operation condition such that the avoidance control is less likely to operate when it is estimated that there is a probability that crossing of a road by the moving object to be avoided will be delayed.

(4): In the aspect (1) described above, the avoidance control unit estimates whether there is a probability that crossing of a road by the moving object to be avoided will be delayed by the avoidance control being performed by the deceleration of the vehicle, and performs the avoidance control by accelerating the vehicle when it is estimated that there is a probability that crossing of a road by the moving object to be avoided will be delayed.

(5): A vehicle control method according to one aspect of the present invention is a vehicle control method executed by a computer mounted on a vehicle, and includes recognizing a moving object that is crossing or is estimated to be about to cross a road on which the vehicle travels in a traveling direction of the vehicle, specifying an area in which the vehicle is traveling, avoiding a contact with a moving object recognized by controlling one or both of steering and/or acceleration and deceleration of the vehicle without depending on an operation of a driver of the vehicle, and changing an operation condition of the avoidance control on the basis of an area specified.

(6): A non-transitory computer-readable storage medium according to one aspect of the present invention is a storage medium which stores a program causing a computer mounted on a vehicle for recognizing a moving object that is crossing or is estimated to be about to cross a road on which the vehicle travels in a traveling direction of the vehicle to specify an area in which the vehicle is traveling, to avoid contact with a moving object recognized by controlling one or both of steering and/or acceleration and deceleration of the vehicle without depending on an operation of a driver of the vehicle, and to change an operation condition of the avoidance control on the basis of the specified area.

According to aspects of (1) to (6), it is possible to execute driving control in accordance with countries and regions.

### BRIEF DESCRIPTION OF THE DRAWINGS

FIG. 1 is a configuration diagram of a vehicle system using a vehicle control device according to an embodiment.

FIG. 2 is a functional configuration diagram of a first control unit and a second control unit.

FIG. 3 is a diagram showing an example of details of individual region operation information.

FIG. 4 is a diagram for describing a process of a crossing delay probability estimation unit.

FIG. 5 is a diagram for describing a state in which it is assumed that a host vehicle has executed deceleration control for contact avoidance.

FIG. 6 is a diagram for describing a process of an acceleration driving control unit.

FIG. 7 is a flowchart showing an example of a process executed by an automated driving control device of the embodiment.

FIG. 8 is a diagram showing an example of a hardware configuration of the automated driving control device of the embodiment.

### DETAILED DESCRIPTION OF THE INVENTION

Hereinafter, an embodiment of a vehicle control device, a vehicle control method, and a storage medium according to the present invention will be described with reference to the drawings. In the following description, description will be provided by using an automated driving vehicle. Automatic driving is causing a vehicle to travel by controlling one or both of steering and/or acceleration or deceleration of the vehicle without depending on an operation of a driver. In an automatically driven vehicle, manual driving may also be performed by a driver. In manual driving, a traveling driving force output device, a brake device, and a steering device of the vehicle to be described below are controlled in accordance with operation amounts of driving operators to be described below.

[Overall Configuration]

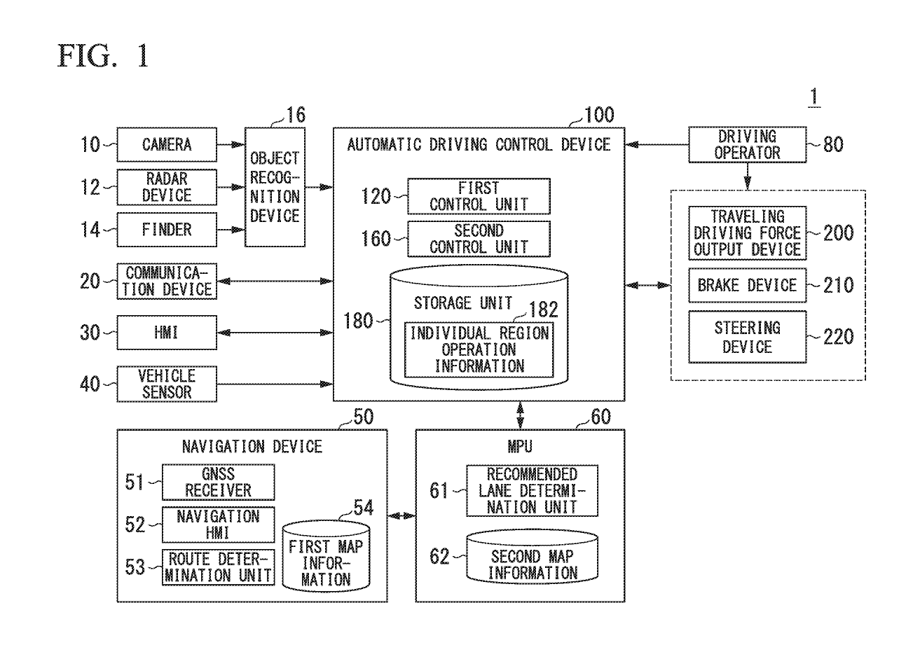

FIG. 1 is a configuration diagram of a vehicle system 1 using a vehicle control device according to an embodiment. A vehicle on which a vehicle system 1 is mounted may be, for example, a vehicle such as a two-wheeled vehicle, a three-wheeled vehicle, or a four-wheeled vehicle, and a driving source thereof is an internal combustion engine such as a diesel engine or a gasoline engine, an electric motor, or a combination of these. In a case that an electric motor is included, the electric motor operates using power generated by a generator connected to an internal combustion engine, or discharge power of a secondary battery or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device (an example of a vehicle control device) 100, a traveling driving force output device 200, a brake device 210, and a steering device 220. These devices and apparatuses are connected to each other by multiple communication lines such as a controller area network (CAN) communication lines, a serial communication line, a wireless communication network, and the like. A configuration shown in FIG. 1 is merely an example, and a part of the configuration may also be omitted, or other components may also be added.

The camera 10 is, for example, a digital camera which uses a solid-state imaging device such as a charge coupled device (CCD) or a complementary metal oxide semiconductor (CMOS). One or a plurality of the cameras 10 are attached to arbitrary places on a vehicle on which the vehicle system 1 is mounted (hereinafter, referred to as a host vehicle M). In a case of imaging the front, the camera 10 is attached to an upper part of a front windshield, a rearview mirror back surface, and the like. The camera 10, for example, periodically repeats imaging of the host vehicle M. The camera 10 may also be a stereo camera.

The radar device 12 emits radio waves such as millimeter waves to the vicinity of the host vehicle M, and detects at least a position of (a position of and a direction to) an object by detecting radio waves (reflected waves) reflected by an object. One or a plurality of the radar devices 12 are attached to arbitrary places on the host vehicle M. The radar device 12 may detect a position and a speed of an object using a frequency modulated continuous wave (FM-CW) method.

The finder 14 is a light detection and ranging (LIDAR) finder. The finder 14 emits light to the vicinity of the host vehicle M, and measures scattered light. The finder 14 detects a distance to a target on the basis of a time between light emission and light reception. The emitted light is, for example, pulse-like laser light. One or a plurality of the finders 14 are attached to arbitrary places on the host vehicle M.

The object recognition device 16 performs a sensor fusion process on results of the detection by some or all of the camera 10, the radar device 12, and the finder 14 to recognize a position, a type, a speed, and the like of an object. The object recognition device 16 outputs a result of the recognition to an automated driving control device 100. The object recognition device 16 may output detection results of the camera 10, the radar device 12, and the finder 14 to the automated driving control device 100 as they are in a case that necessary.

The communication device 20 communicates with other vehicles present in the vicinity of the host vehicle M or communicates with various types of server device via a radio base station using, for example, a cellular network, a Wi-Fi network, Bluetooth (registered trademark), dedicated short range communication (DSRC), or the like.

A HMI 30 presents various types of information to a driver of the host vehicle M, and receives an operation input by the driver. The HMI 30 includes various display devices, a speaker, a buzzer, a touch panel, a switch, a key, and the like.

The vehicle sensor 40 includes a speed sensor for detecting a speed of the host vehicle M, an acceleration sensor for detecting an acceleration thereof, a yaw rate sensor for detecting an angular speed around a vertical axis, a direction sensor for detecting a direction of the host vehicle M, and the like.

The navigation device 50 includes, for example, a global navigation satellite system (GNSS) receiver 51, a navigation HMI 52, and a route determination unit 53, and stores first map information 54 in a storage device such as a hard disk drive (HDD) or a flash memory. The GNSS receiver 51 specifies a position of the host vehicle M on the basis of a signal received from GNSS satellites. The position of the host vehicle M may be specified or supplemented by an inertial navigation system (INS) which uses an output of the vehicle sensor 40. The navigation HMI 52 includes a display device, a speaker, a touch panel, a key, and the like. The navigation HMI 52 may also be shared by a part or all of the HMI 30 described above. The route determination unit 53 determines, for example, a route (hereinafter, a route on the map) to a destination input by a driver using the navigation HMI 52 from a position of the host vehicle M specified by the GNSS receiver 51 (or any input position) with reference to the first map information 54. The first map information 54 is, for example, information in which a road shape is expressed by a link indicating a road and nodes connected by the links. The first map information 54 may also include a road curvature, point of interest (POI) information, and the like. A route on the map determined by the route determination unit 53 is output to the MPU 60. The navigation device 50 may perform route guidance using the navigation HMI 52 on the basis of a route on the map determined by the route determination unit 53. The navigation device 50 may also be realized, for example, by a function of a terminal device such as a smartphone or a tablet terminal possessed by the driver. The navigation device 50 may transmit a current position and a destination to the navigation server via the communication device 20, and acquire a route on the map returned from the navigation server.

The MPU 60 functions as, for example, a recommended lane determination unit 61, and holds second map information 62 in the storage device such as an HDD or a flash memory. The recommended lane determination unit 61 divides a route presented from the navigation device 50 into a plurality of blocks (for example, divides the route into 100 [m] intervals with respect to a vehicle traveling direction), and determines a recommended lane for each block with reference to the second map information 62. The recommended lane determination unit 61 makes a determination of on which lane from the left to travel. The recommended lane determination unit 61 determines a recommended lane such that the host vehicle M can travel on a reasonable route for proceeding to a branch destination in a case that there are branching points, merging points, and the like.

The second map information 62 is map information with higher accuracy than the first map information 54. The second map information 62 includes, for example, information on a center of the lane or information on boundaries of lanes. The second map information 62 may include administrative districts such as countries, prefectures, cities, towns, villages, and states, road information, traffic regulations information, address information (address and postal code), facility information, phone number information, and the like. The second map information 62 may be updated at any time by accessing other devices using the communication device 20.

The driving operator 80 includes, for example, an accelerator pedal, a brake pedal, a shift lever, a steering wheel, a modified steering wheel, a joystick, and other operators. The driving operator 80 is attached to a sensor for detecting an amount of an operation or a presence or absence of an operation. A result of the detection is output to the automated driving control device 100 or the traveling driving force output device 200, and one or both of the brake device 210 and the steering device 220.

The automated driving control device 100 includes, for example, a first control unit 120, a second control unit 160, and a storage unit 180. Among these components, each of the first control unit 120 and the second control unit 160 is realized, for example, by a hardware processor such as a central processing unit (CPU) executing a program (software). A part or all of these components may be realized by hardware (a circuit unit including a circuitry) such as a large scale integration (LSI), an application specific integrated circuit (ASIC), a field-programmable gate array (FPGA), a graphic processing unit (GPU), and may also be realized by collaboration between software and hardware.

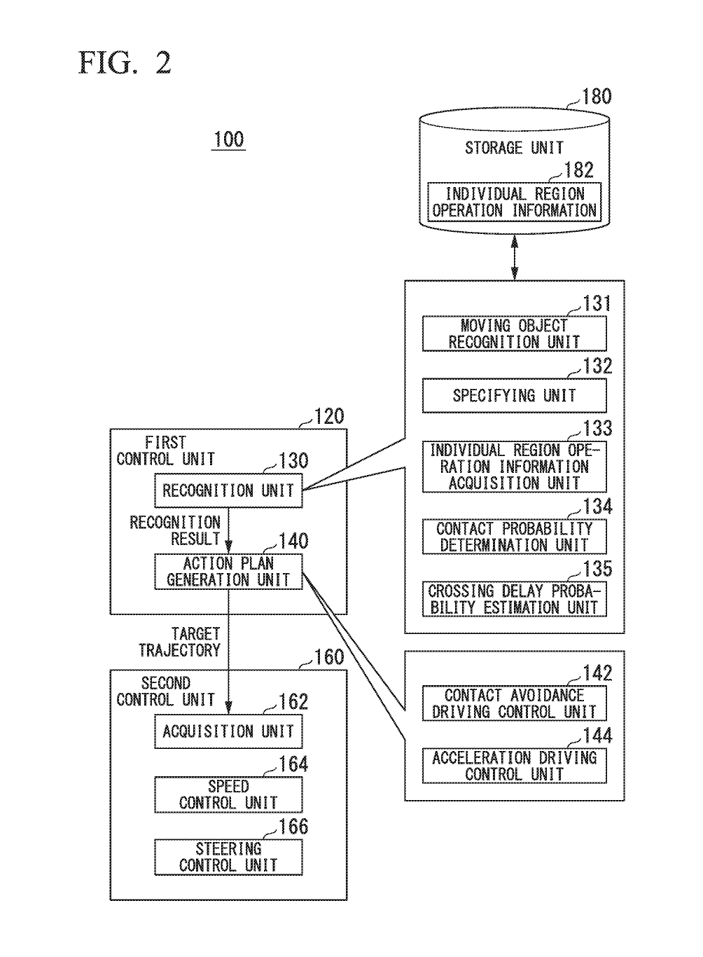

FIG. 2 is a functional configuration diagram of the first control unit 120 and the second control unit 160. The storage unit 180 is shown in FIG. 2. The first control unit 120 includes, for example, a recognition unit 130 and an action plan generation unit 140. The recognition unit 130 includes, for example, a moving object recognition unit 131, a specifying unit 132, an individual region operation information acquisition unit 133, a contact probability determination unit 134, and a crossing delay probability estimation unit 135. The action plan generation unit 140 includes, for example, a contact avoidance driving control unit 142, and an acceleration driving control unit 144. A combination of the individual region operation information acquisition unit 133, the contact probability determination unit 134, the crossing delay probability estimation unit 135, the contact avoidance driving control unit 142, the acceleration driving control unit 144, and the second control unit 160 is an example of an “avoidance control unit.”

The first control unit 120 realizes a function based on artificial intelligence (AI) and a function based on a given model in advance in parallel. For example, a function of “recognizing an intersection” is executed by both recognizing an intersection using an image recognition method using deep learning and the like, and recognizing based on previously given conditions (a pattern matchable signal, road markings, and the like), and is realized by scoring both and comprehensively evaluating them.

As a result, reliability of automated driving is guaranteed.

The recognition unit 130 recognizes a state such as the position, the speed, the acceleration, and the like of an object in the vicinity of the host vehicle M on the basis of information input from the camera 10, the radar device 12, and the finder 14 via the object recognition device 16. Objects may be other vehicles and stationary obstacles. The position of an object is, for example, recognized as a position using absolute coordinates with a representative point of the host vehicle M (a center of gravity, a drive axis center, and the like) as an origin point, and is used for control. The position of an object may be represented by a representative point such as a center of gravity or a corner of the object, and may also be represented by a representative area. A “state” of an object may include an acceleration or jerk of the object, or a “behavior state” (for example, whether lane changing is being performed or is intended to be performed). The recognition unit 130 recognizes a shape of a curve along which the host vehicle M is about to pass on the basis of a captured image of the camera 10. The recognition unit 130 converts the shape of a curve into a real plane from the captured image of the camera 10, and outputs, for example, two-dimensional point sequence information or information expressed by using a model equivalent thereto to the action plan generation unit 140 as information indicating the shape of a curve.

The recognition unit 130 recognizes a lane (a traveling lane) on which the host vehicle M is traveling. For example, the recognition unit 130 compares a pattern of a road lane markings obtained from the second map information 62 (for example, an arrangement of solid lines and broken lines) with a pattern of a road lane marker in the vicinity of the host vehicle M recognized from an image captured by the camera 10 to recognize a traveling lane. The recognition unit 130 may recognize a traveling lane by recognizing not only a road lane marker but also a lane boundary (a road boundary) including a road lane maker, a road shoulder, a curb stone, a median strip, a guardrail, and the like. In this recognition, the position of the host vehicle M acquired by the navigation device 50 or a result of the process of the INS may be additionally taken into account. The recognition unit 130 recognizes a stop line, a road sign, a signal, a toll booth, and other road events.

The recognition unit 130 recognizes a position and posture of the host vehicle M with respect to a traveling lane in a case that the traveling lane is recognized. The recognition unit 130 may recognizes, for example, a deviation of a reference point of the host vehicle M from a lane center and an angle formed with respect to a line connecting the lane center in a traveling direction of the host vehicle M as a relative position and posture of the host vehicle M with respect to the traveling lane. Alternatively, the recognition unit 130 may also recognize a position of the reference point of the host vehicle M and the like with respect to a side end portion of one of traveling lanes (a road lane marker or a road boundary) as a relative position of the host vehicle M with respect to the traveling lane.

The recognition unit 130 may derive a recognition accuracy in the recognition process described above, and output it to the action plan generation unit 140 as recognition accuracy information. For example, the recognition unit 130 generates recognition accuracy information on the basis of a frequency with which a road lane marker can be recognized in a certain period. Functions of the moving object recognition unit 131, the specifying unit 132, the individual region operation information acquisition unit 133, the contact probability determination unit 134, and the crossing delay probability estimation unit 135 of the recognition unit 130 will be described below.

The action plan generation unit 140, in principle, generates a target trajectory on which the host vehicle M will travel such that the host vehicle M travels a recommended lane determined by the recommended lane determination unit 61 and automated driving associated with circumstances of the host vehicle M is furthermore executed. The target trajectory includes, for example, a speed element. For example, the target trajectory is expressed as a sequence of places (trajectory points) to be reached by the host vehicle M. The trajectory points are places at which the host vehicle M will arrive at respective traveling distances (for example, about several [m]) as distances along a road, and, separately from this, a target speed and a target acceleration for each of predetermined sampling times (for example, a fraction of a [sec]) are generated as a part of the target trajectory. Functions of the contact avoidance driving control unit 142 and the acceleration driving control unit 144 of the action plan generation unit 140 will be described below.

The second control unit 160 includes, for example, an acquisition unit 162, a speed control unit 164, and a steering control unit 166. The acquisition unit 162 acquires information of a target trajectory generated by the action plan generation unit 140, the contact avoidance driving control unit 142, or the acceleration driving control unit 144, and causes it to be stored in a memory (not shown). The speed control unit 164 controls the traveling driving force output device 200 or the brake device 210 on the basis of a speed element accompanying a target trajectory stored in the memory. The steering control unit 166 controls the steering device 220 in accordance with a curvature degree of the target trajectory stored in the memory. The processes of the speed control unit 164 and the steering control unit 166 are realized by, for example, a combination of feedforward control and feedback control. As an example, the steering control unit 166 combines and executes feedforward control in accordance with a curvature of a road ahead of the host vehicle M and feedback control based on a deviation from the target trajectory.

The storage unit 180 is realized by an HDD, a flash memory, a random access memory (RAM), a read only memory (ROM), and the like. The storage unit 180 stores, for example, individual region operation information 182 and the other pieces of information.

The traveling driving force output device 200 outputs a traveling driving force (torque) for a vehicle to travel to a driving wheel. The traveling driving force output device 200 includes, for example, a combination of an internal combustion engine, an electric motor, a transmission, and the like, and an ECU that controls them. The ECU controls the above constituents according to information input from the second control unit 160 or information input from the driving operator 80.

The brake device 210 includes, for example, brake calipers, a cylinder through which to transmit hydraulic pressure to the brake calipers, an electric motor which generates hydraulic pressure in the cylinder, and a brake ECU. The brake ECU controls the electric motor according to the information input from the second control unit 160 or the information input from the driving operator 80 such that brake torque in accordance with a braking operation is output to each vehicle wheel. The brake device 210 may include a mechanism that transmits hydraulic pressure generated by an operation of a brake pedal included in the driving operator 80 to the cylinder via a master cylinder as a backup. The brake device 210 is not limited to the above configuration, and may be an electronically controlled hydraulic braking device that transmits hydraulic pressure of the master cylinder to the cylinder by controlling an actuator according to the information input from the second control unit 160.

The steering device 220 includes, for example, a steering ECU and an electric motor.

The electric motor, for example, changes a direction of a steering wheel by applying a force to a rack and pinion mechanism. The steering ECU drives the electric motor such that the direction of a steering wheel is changed according to the information input from the second control unit 160 and the information input from the driving operator 80.

[Function of Moving Object Recognition Unit]

The moving object recognition unit 131 recognizes a moving object that is crossing or is estimated to be about to cross a road in the traveling direction of the host vehicle M. A moving object is, for example, a pedestrian, a bicycle, a motorcycle, and a robot that can move by full automation or steering. In the following description, a pedestrian is used as an example of the moving object, but this may also be replaced with another moving object. For example, the moving object recognition unit 131 recognizes a pedestrian who crosses or is estimated to cross a road in the traveling direction of the host vehicle according to a shape, a size, a behavior, and the like of an object included in the captured image of the camera 10. The moving object recognition unit 131 recognizes a pedestrian who moves toward a road from a position outside the road on which the host vehicle M travels as a pedestrian who is estimated to cross the road. The moving object recognition unit 131 recognizes a position, a movement direction, and a movement speed of the recognized pedestrian.

[Function of Specifying Unit]

The specifying unit 132 specifies an area to which the host vehicle M travels. For example, the specifying unit 132 collates the position of the host vehicle M recognized by the recognition unit 130 with the first map information 54 or the second map information 62, and acquires information for specifying an area to which the host vehicle M travels.

[Function of Individual Region Operation Information Acquisition Unit]

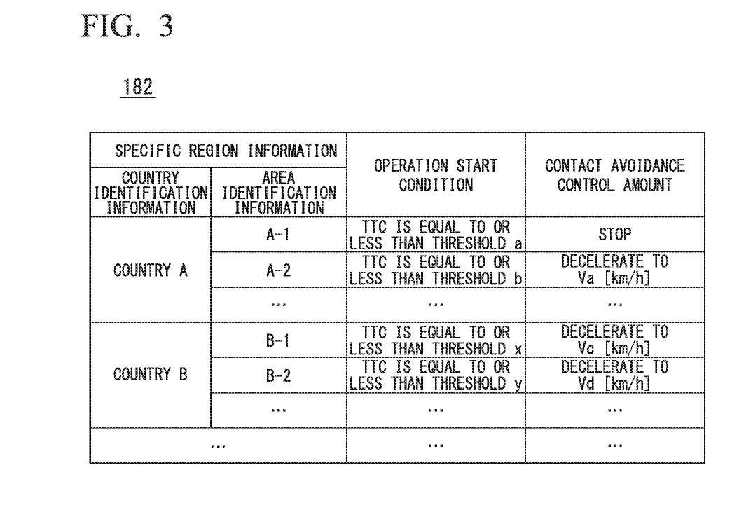

The individual region operation information acquisition unit 133 refers to the individual region operation information 182 stored by the storage unit 180 on the basis of area information specified by the specifying unit 132, and acquires an operation threshold value for contact avoidance control associated with the area information. FIG. 3 is a diagram showing an example of details of the individual region operation information 182. The individual region operation information 182 is information in which an operation start condition and a contact avoidance control amount are associated with specified area information. The specified area information includes, for example, country identification information and area identification information. The country identification information is information for identifying a country in which the host vehicle M travels. The area identification information is information for identifying an area for each country, and is an administrative district such as prefecture, a municipality, or a state.

The operation start condition is, for example, a condition for starting an operation of contact avoidance driving control of the host vehicle M. The contact avoidance driving control is driving control for the host vehicle M to avoid contact with a pedestrian. An operation of the contact avoidance driving control means, for example, that a predetermined control amount is given to at least one of the traveling driving force output device 200, the brake device 210, and the steering device 220 by the contact avoidance driving control unit 142. The operation start condition includes, for example, a condition related to an allowance time TTC until the host vehicle M will come into contact with a pedestrian. The TTC is calculated, for example, by dividing a relative distance by a relative speed.

The contact avoidance control amount includes, for example, information on a speed amount that indicates how far the host vehicle M is caused to be decelerated. The speed amount may include an amount of difference from a current speed. The contact avoidance control amount may include information on stopping of the host vehicle M. Furthermore, the contact avoidance control amount may include, for example, information on a steering amount of the host vehicle M. The individual region operation information acquisition unit 133 acquires an operation start condition and a contact avoidance control amount associated with a traveling area by performing collation with the specified area information of the individual region operation information 182 on the basis of information on an area in which the host vehicle M travels. The individual region operation information acquisition unit 133 may access a management server managed by the individual region operation information 182 using the communication device 20, and acquire an operation start condition and a contact avoidance control amount associated with the information on an area in which the host vehicle M travels from the management server.

[Function of Contact Probability Determination Unit]

The contact probability determination unit 134 determines a probability that there is a contact between a pedestrian and the like recognized by the moving object recognition unit 131 and the host vehicle M. For example, the contact probability determination unit 134 calculates an allowance time TTC for a pedestrian whose relative distance is within a predetermined value on the basis of the relative distance and the relative speed of the pedestrian. Then, in a case that the calculated TTC satisfies an operation start condition acquired by the individual region operation information acquisition unit 133, the contact probability determination unit 134 determines that there is a probability of a contact with the pedestrian.

For example, in a case that the country identification information of a traveling place of the host vehicle M is a country A and the area identification information thereof is A-1, the contact probability determination unit 134 determines a probability of a contact with a pedestrian by comparing TTC with a threshold value a. In a case that the country identification information of a traveling place of the host vehicle M is a country A and the area identification information thereof is A-2, the contact probability determination unit 134 determines a probability of a contact with a pedestrian by comparing TTC with a threshold value b. The contact probability determination unit 134 determines that there is a probability of a contact between the host vehicle M and a pedestrian in a case that TTC is equal to or less than a threshold value, and determines that there is no probability of a contact between the host vehicle M and a pedestrian in a case that TTC exceeds the threshold value.

In this manner, on the premise that there should be no contact with a pedestrian, it is possible to change an operation timing of contact avoidance driving control by changing a threshold value for determination by the contact probability determination unit 134 for each area in which the host vehicle M is traveling.

[Function of Contact Avoidance Driving Control Unit]

The contact avoidance driving control unit 142 executes driving control for avoiding a contact between the host vehicle M and a pedestrian in a case that it is determined that there is a probability of the contact between the host vehicle M and a pedestrian by the contact probability determination unit 134. Specifically, the contact avoidance driving control unit 142 controls one or both of the steering and the acceleration and deceleration of the host vehicle M on the basis of a contact avoidance control amount acquired by the individual region operation information acquisition unit 133, and executes automated driving such that the host vehicle M is unlikely to come into contact with a pedestrian.

For example, in a case that the country identification information of a traveling place of the host vehicle M is a country A and the area identification information thereof is A-1, the contact avoidance driving control unit 142 generates a target trajectory in which the host vehicle M is stopped. In a case that the country identification information of a traveling place of the host vehicle M is a country A and the area identification information thereof is A-2, the contact avoidance driving control unit 142 generates a target trajectory in which the host vehicle M is decelerated from a current speed to a speed Va [km/h]. The second control unit 160 causes the host vehicle M to travel along the target trajectory generated by the contact avoidance driving control unit 142, and executes contact avoidance driving of the host vehicle M. In this manner, by changing a contact avoidance control amount for each area in which the host vehicle M travels, it is possible to execute contact avoidance driving in accordance with an area. Therefore, it is possible to execute automated driving control suitable for traffic circumstances according to country or area.

[Function of Crossing Delay Probability Estimation Unit]

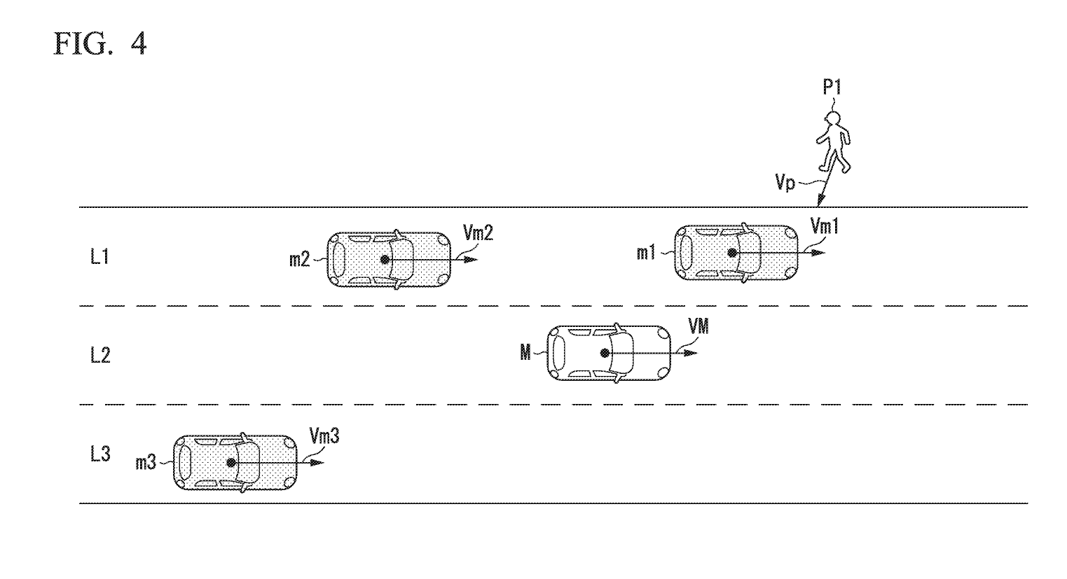

The crossing delay probability estimation unit 135 estimates whether there is a probability that crossing of a road by a pedestrian is delayed by the host vehicle M performing control of avoiding a contact with the pedestrian. FIG. 4 is a diagram for describing a process of the crossing delay probability estimation unit 135. FIG. 4 shows roads of three lanes L1 to L3 which are examples of a plurality of lanes, the host vehicle M, and three other vehicles m1 to m3. It is assumed that other vehicles m1 and m2 travel on a lane L1 at a speed Vm1 and a speed Vm2, respectively, the host vehicle M travels on a lane L2 at a speed Vm, and the other vehicle m3 travels on a lane L3 at a speed Vm3. In the example of FIG. 4, a pedestrian P1 intends to cross the lanes L1 to L3 at a speed Vp is shown.

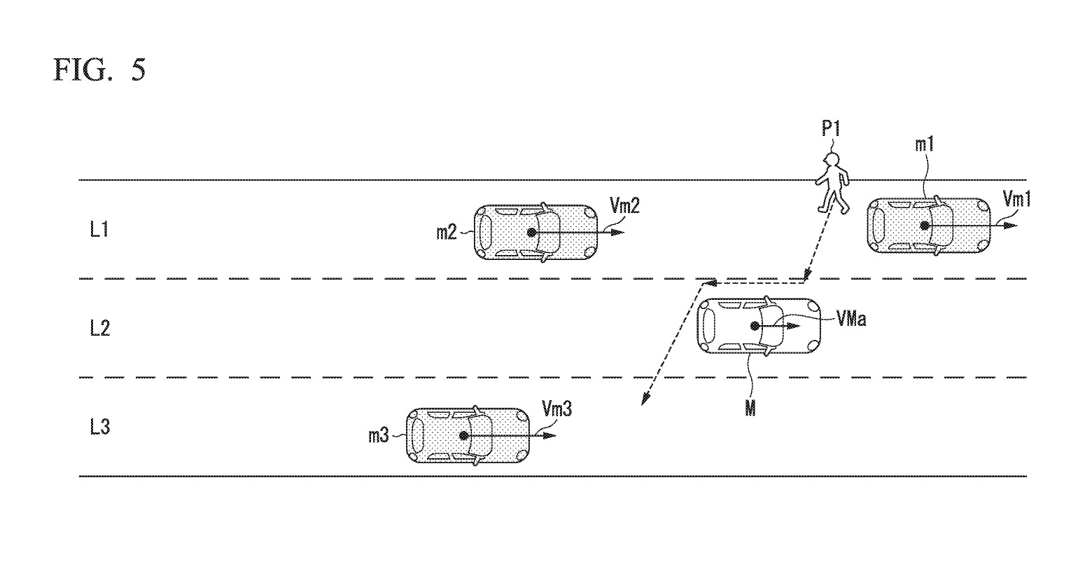

If control to avoid contact with the pedestrian P1 is performed on the basis of a control amount of contact avoidance driving associated with an area in which the host vehicle M travels, the crossing delay probability estimation unit 135 estimates whether there is a probability that crossing of the lanes L1 to L3 by the pedestrian P1 will be delayed due to an influence of the host vehicle M. FIG. 5 is a diagram for describing a state in which it is assumed that the host vehicle M has executed deceleration control for contact avoidance. The crossing delay probability estimation unit 135 estimates that the pedestrian P1 crosses the lanes L1 to L3 on the basis of a current movement speed Vp and a movement direction of the pedestrian P1, and predicts a change in the movement speed of the pedestrian P1 and a change in the movement direction of the pedestrian P1 in a case that the host vehicle M is decelerated to the speed Vma (VM>VMa) for contact avoidance. Thus, the crossing delay probability estimation unit 135 estimates that there is a probability of crossing of lanes by the pedestrian P1 being delayed if contact avoidance driving is executed in a case that it is predicted that the movement speed of the pedestrian P1 will decrease or the movement direction thereof will change.

The crossing delay probability estimation unit 135 may estimate whether there is a probability of crossing of a road by the pedestrian P1 being delayed due to an influence of other vehicles m1 to m3 that travel the lanes L1 to L3 according to the contact avoidance control of the host vehicle M. In the example of FIG. 5, the crossing delay probability estimation unit 135 first predicts a current movement speed Vp and a movement route of the pedestrian P1 in a case that the host vehicle M has executed deceleration control for contact avoidance. Next, the crossing delay probability estimation unit 135 predicts whether there is a further change in the walking speed or the movement direction of the pedestrian P1 due to an existence of another vehicle m3 in a case that the pedestrian P1 intends to cross the lane L3 on the basis of the predicted movement speed Vp and movement route. Then, the crossing delay probability estimation unit 135 estimates that there is a probability of crossing of lanes by the pedestrian P1 being delayed by the host vehicle M executing contact avoidance driving in a case that it is predicted that the movement speed of the pedestrian P1 is decelerated or the movement direction thereof is changed due to the influence of another vehicle m3.

In a case that the crossing delay probability estimation unit 135 has estimated that there is a probability of crossing of lanes by the pedestrian P1 being delayed, the operation start condition of avoidance driving control of the host vehicle M is changed such that the avoidance driving control is less likely to operate. Changing the operation start condition such that the avoidance driving control is less likely to operate is, for example, changing a threshold value a to a threshold value a′ obtained by lowering the threshold value a by a predetermined value in a case that it is set as an operation start condition that TTC is equal to or less than the threshold value a. As a result, the host vehicle M can travel smoothly without inhibiting crossing walking of a pedestrian.

The crossing delay probability estimation unit 135 may output an instruction to cause the acceleration driving control unit 144 to accelerate the host vehicle M in a case that it is estimated that there is a probability that the crossing of the lanes L1 to L3 by the pedestrian P1 is delayed by avoidance control being performed by, for example, the deceleration of the host vehicle M.

[Function of Acceleration Driving Control Unit]

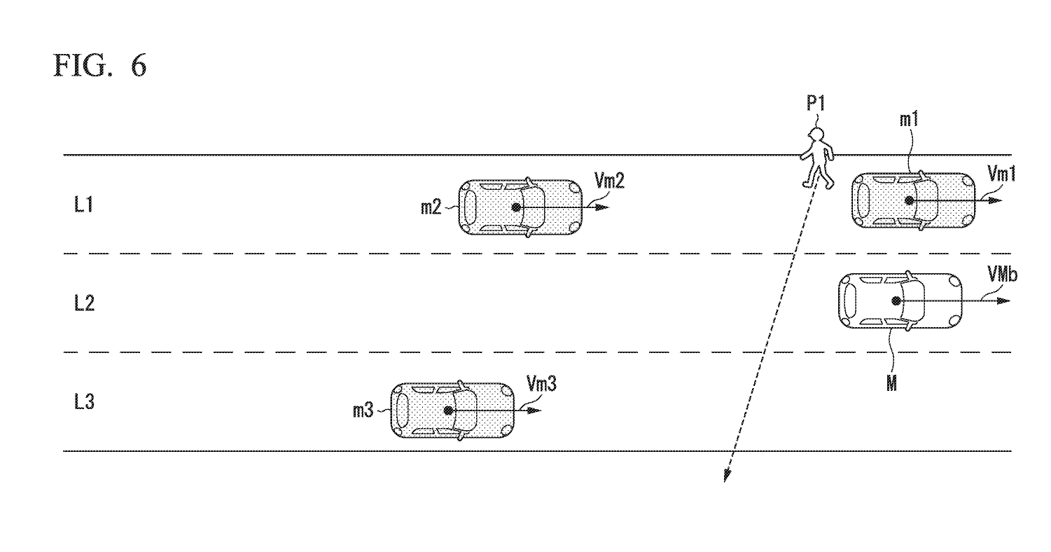

The acceleration driving control unit 144 causes the host vehicle M to be accelerated on the basis of an instruction from the crossing delay probability estimation unit 135. FIG. 6 is a diagram for describing a process of the acceleration driving control unit 144. The acceleration driving control unit 144 generates a target trajectory in which the speed of the host vehicle M is accelerated from a current speed by a predetermined value (for example, about 10 [km/h]) in a case that an instruction by the crossing delay probability estimation unit 135 to cause the host vehicle M to be accelerated is received. The crossing delay probability estimation unit 135 may generate a target trajectory in which the host vehicle M is temporarily accelerated, for example, in a section until the host vehicle M passes by a side of the pedestrian P1 in a traveling direction of a lane or a section until a predetermined distance (for example, about 10 [m]) after the passing, and returns to an original speed after having passed this section. In a case that there is a preceding vehicle on a traveling lane of the host vehicle M, the acceleration driving control unit 144 generates a target trajectory in which the host vehicle M is accelerated in a range in which it does not come into contact with the preceding vehicle. The second control unit 160 causes the host vehicle M to travel along the target trajectory generated by the acceleration driving control unit 144.

In the example of FIG. 6, the acceleration driving control unit 144 accelerates the host vehicle M from the speed VM to a speed VMb (VM<VMb), and thereby a space behind another vehicle m1 and the host vehicle M is enlarged. For this reason, the pedestrian P1 can cross the lanes L1 to L3 with ease.

[Process Flow]

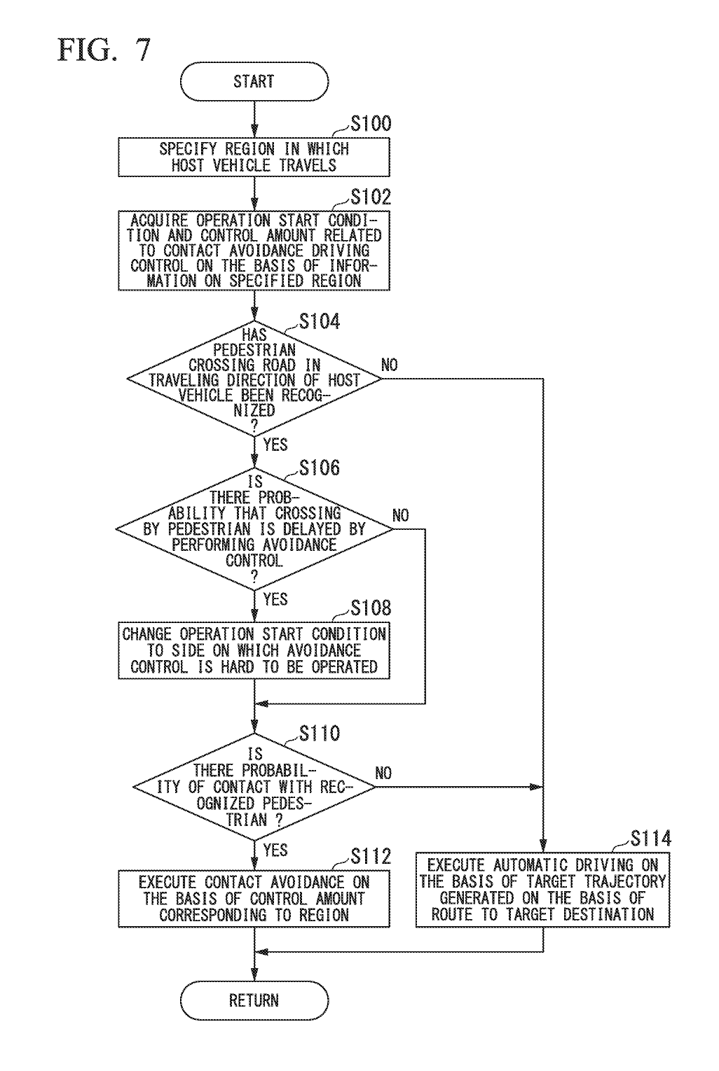

FIG. 7 is a flowchart showing an example of a process executed by the automated driving control device 100 of the embodiment. Processes of the present flowchart may be repeatedly executed, for example, at predetermined time intervals or predetermined timings.

First, the specifying unit 132 specifies an area in which the host vehicle M is traveling (step S100). Next, the individual region operation information acquisition unit 133 collates information on the specified area with the individual region operation information 182 stored in the storage unit 180, and acquires an operation start condition for the contact avoidance driving control and a control amount for contact avoidance (step S102). Then, the moving object recognition unit 131 determines whether a pedestrian who crosses or who is estimated to cross a road on which the host vehicle M travels in the traveling direction of the host vehicle M has been recognized (step S104). In a case that it is determined that a pedestrian who crosses a road on which the host vehicle M travels in the traveling direction of the host vehicle M has been recognized, the crossing delay probability estimation unit 135 determines whether there is a probability that the crossing of the pedestrian is delayed by performing control to avoid contact with the pedestrian (step S106).

In a case that it is determined that there is a probability that the crossing of the pedestrian is delayed, the operation start condition is changed to a side on which control to avoid contact is hard to be operated (step S108). After the end of step S108 or in a case that it is determined that there is no probability that the crossing of the pedestrian is delayed by performing the control to avoid contact according to the process of step S106, the contact probability determination unit 134 determines whether there is a probability of a contact with the pedestrian on the basis of an operation start condition associated with an area, or an operation start condition changed to the side on which the control to avoid contact is hard to be operated (step S110).

In a case that there is a probability of a contact with a recognized pedestrian, the contact avoidance driving control unit 142 executes the control to avoid contact on the basis of a control amount associated with an area (step S112). In a case that a pedestrian existing in the traveling direction of the host vehicle M is not recognized in the process of step S104, or in a case that it is determined that there is no probability of a contact with a recognized pedestrian in the process of step S110, automated driving is executed on the basis of a target trajectory generated on the basis of a route to a destination (step S114). As a result, the processes of the present flowchart end.

According to the embodiment described above, it is possible to execute driving control for contact avoidance depending on a country or region by including the moving object recognition unit 131 which recognizes a moving object in the vicinity of the host vehicle M, the specifying unit 132 which specifies an area in which the vehicle M travels, and avoidance control units which are the contact probability determination unit 134 and the contact avoidance driving control unit 142 that avoid contact with a moving object recognized by the moving object recognition unit 131 by controlling one or both of steering and/or acceleration or deceleration of the vehicle without depending on an operation of a driver of the vehicle and change an operation condition of avoidance control on the basis of an area specified by the specifying unit 132.

According to the present embodiment, for example, in a case that the host vehicle M travels across countries and areas, since an operation start condition and a contact avoidance control amount of contact avoidance driving control are switched automatically, there is no burden such as resetting, by a driver, an operation start condition and a contact avoidance control amount. For example, depending on a country or region, even in a case that a pedestrian and the like predict a movement of a vehicle and boldly perform crossing, by operating contact avoidance driving at an operation timing in accordance with a country or an area, it is possible to travel without confounding the prediction of a pedestrian and the like, and as a result, it is possible to inhibit the crossing of a road by the pedestrian and the like from being delayed. As described above, according to the present embodiment, it is possible to execute automated driving control suitable for traffic circumstances for each country or area.

[Hardware Configuration]

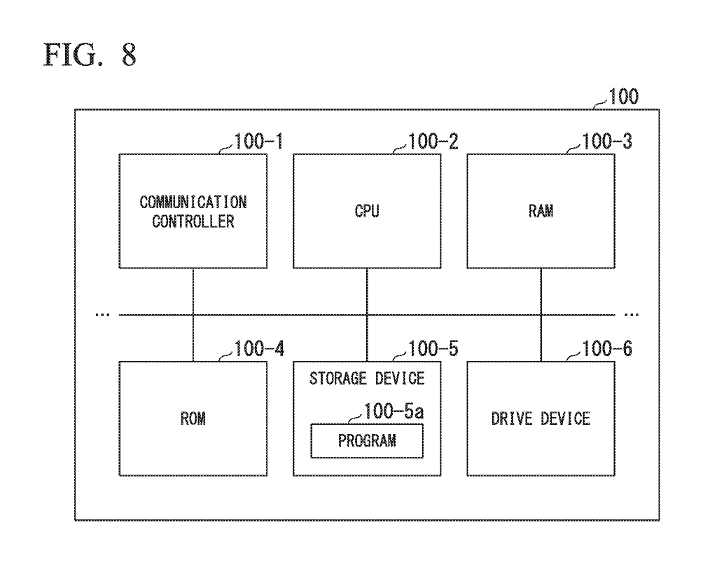

The automated driving control device 100 of the embodiment described above is realized by, for example, a hardware configuration as shown in FIG. 8. FIG. 8 is a diagram showing an example of a hardware configuration of the automated driving control device 100 of the embodiment.

The automated driving control device 100 is configured to include a communication controller 100-1, a CPU 100-2, a RAM 100-3, a ROM 100-4, a secondary storage device 100-5 such as a flash memory or an HDD, and a drive device 100-6 which are connected to each other by an internal bus or a dedicated communication line. A portable storage medium such as an optical disc is mounted on the drive device 100-6. A program 100-5a stored in the secondary storage device 100-5 is developed in the RAM 100-3 by a DMA controller (not shown) and the like, and the first control unit 120 and the second control unit 160 are realized by the program being executed by the CPU 100-2. A program to which the CPU 100-2 refers may be stored in a portable storage medium mounted on the drive device 100-6, and may also be downloaded from another device via a network NW.

The present embodiment can be realized as follows.

A vehicle control device which includes a storage device for storing information, and a hardware processor which executes a program stored in the storage device, in which the hardware processor is configured to execute, by executing the program, a moving object recognition process of recognizing a moving object that is crossing or is estimated to be about to cross a road on which a vehicle is traveling in a traveling direction of the vehicle, a specification process of specifying an area in which the vehicle is traveling, and an avoidance control process of avoiding a contact with a moving object recognized by the moving object recognition process by controlling one or both of steering and/or acceleration or deceleration of the vehicle without depending on an operation of a driver of the vehicle, and of changing an operation condition of the avoidance control on the basis of an area specified by the specification process.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a moving object recognition unit configured to recognize a moving object that is crossing or is estimated to be about to cross a road on which a vehicle is traveling in a traveling direction of the vehicle;
a specifying unit configured to specify an area in which the vehicle is traveling; and
an avoidance control unit configured to avoid contact with a moving object recognized by the moving object recognition unit by controlling one or both of steering and/or acceleration or deceleration of the vehicle without depending on an operation of a driver of the vehicle and to change an operation condition of the avoidance control on the basis of an area specified by the specifying unit.

2. The vehicle control device according to claim 1,
wherein the avoidance control unit estimates whether there is a probability that crossing of a road by the moving object to be avoided will be delayed by performing the avoidance control, and changes the operation condition such that the avoidance control is less likely to operate in a case that it is estimated that there is a probability that the crossing of a road of the moving object to be avoided will be delayed.

3. The vehicle control device according to claim 1,
wherein the avoidance control unit, in a case that the road on which the vehicle travels is a road having a plurality of lanes, estimates whether there is a probability that crossing of a road by the moving object to be avoided will be delayed due to an influence of other vehicles traveling on the plurality of lanes by performing the avoidance control, and changes the operation condition such that the avoidance control is less likely to operate in a case that it is estimated that there is a probability that crossing of a road by the moving object to be avoided will be delayed.

4. The vehicle control device according to claim 1,
wherein the avoidance control unit estimates whether there is a probability that crossing of a road by the moving object to be avoided will be delayed by the avoidance control being performed by the deceleration of the vehicle, and performs the avoidance control by accelerating the vehicle in a case that it is estimated that there is a probability that crossing of a road by the moving object to be avoided will be delayed.

5. A vehicle control method which is executed by a computer mounted on a vehicle comprising:
recognizing a moving object that is crossing or is estimated to be about to cross a road on which the vehicle travels in a traveling direction of the vehicle;
specifying an area in which the vehicle is traveling;
avoiding a contact with a moving object recognized by the moving object recognition unit by controlling one or both of steering and/or acceleration and deceleration of the vehicle without depending on an operation of a driver of the vehicle; and
changing an operation condition of the avoidance control on the basis of an area specified.

6. A non-transitory computer-readable storage medium which stores a program causing a computer mounted on a vehicle including a moving object recognition unit for recognizing a moving object that is crossing or is estimated to be about to cross a road on which the vehicle travels in a traveling direction of the vehicle to
specify an area in which the vehicle is traveling,
avoid contact with a moving object recognized by the moving object recognition unit by controlling one or both of steering and/or acceleration and deceleration of the vehicle without depending on an operation of a driver of the vehicle, and
change an operation condition of the avoidance control on the basis of the specified area.
